(19) United States
(12) Patent Application Publication
(10) Pub. No.: US 2003/0150704 A1
(43) Pub. Date: Aug. 14, 2003

(54) Portable water purifier

(76) Inventor: Juan M. Posada, Ventura, CA (US)

Correspondence Address: KENNETH J. HOVET, NORDMAN, CORMANY, HAIR & COMPTON, P.O. BOX 9100, OXNARD, CA, 93031-9100, US

(21) Appl. No.: 10/337,616

(22) Filed: Jan. 6, 2003

Related U.S. Application Data
(60) Provisional application No. 60/345,486, filed on Jan. 7, 2002.

(51) Int. Cl. B01D 1/30; B01D 3/42; C02F 1/14

(52) U.S. Cl. 203/1; 203/22; 203/71; 203/100; 203/DIG. 1; 203/DIG. 8; 202/155; 202/172; 202/200; 202/234; 202/237; 159/23; 159/26.1; 159/28.6; 159/44; 159/903

(57) ABSTRACT

One or more water distillation chambers are provided wherein water containing salt or other impurities enters an upper inlet at a chamber and flows down a solar heated evaporative surface. The evaporative surface may be the interior of a pipe or the surface of a bottom sheet enclosed by a cover. In this way, the steam produced in the process will be constrained and be guided into a steam drum. The steam drum interior has cooling tubes whereby vapor entering the steam drum will be condensed into fresh water and collected for use. The cover may be heated to limit the amount of vapor condensing back into water before entering the steam drum. Multiple evaporation chambers and steam collection stages limit the distance water vapor must travel before entering a steam drum of a given stage, thereby minimizing the loss of water vapor through re-condensation before the vapor enters the steam drum.

This application claims priority from Provisional Application No. 60/345,486, filed Jan. 7, 2002.

### BACKGROUND OF THE INVENTION

1. Field of the Invention

The present invention pertains generally to water purifiers. More specifically, the present invention applies to water distillation assemblies which use solar energy to heat water for removal of salt and other impurities therefrom.

2. Description of Related Art

Current demands for fresh water have given rise to a variety of apparatuses and processes for deriving fresh water from salt or contaminated water. Off-shore oil platforms derive drinking water from the distillation of salt water. Contaminated and polluted groundwater can be rendered drinkable through a variety of purification processes. Various forms of water purification include filtration, reverse osmosis, and distillation. In many applications, distillation is regarded as superior to other purification processes in that it is useful both in distilling fresh water from salt water, and from removing toxic chemicals from contaminated ground water. Distillation however has several drawbacks. Many distillation processes utilize energy in a highly inefficient manner. Additionally, many existing distillation processes utilize metered energy or other expensive energy sources. There exists therefore a need for a distillation process that utilizes inexpensive energy and that is highly efficient in its consumption of energy for the distillation of water.

### SUMMARY OF THE INVENTION

The present invention is directed to distillation processes and apparatus that utilize solar energy, thereby reducing or eliminating the expense of metered energy. In general, the apparatus includes a steam generating means having an upper section, a mid-section and a lower section for converting incoming raw water to steam. In one version, the steam generating means comprises a first thermally conductive evaporation member having a first end and a second end. The first end is disposed at a higher altitude than the second end, thereby allowing water to gravity flow down the evaporation member. A first water inlet proximate the first end of the first evaporation member is configured to receive raw water from an external source and to direct the water down the evaporation member.

A first heating apparatus is configured to impart heat into the water flowing down the evaporation member, thereby converting a portion of water into water vapor. A first water outlet is proximate the second end of the first evaporation member for draining the water from the second end of the first evaporation member. A cover is coupled to the evaporation member for channeling water vapor into a first steam drum.

According to one embodiment, the first evaporation member comprises a plurality of heat conductive tubes. According to this embodiment, the cover for channeling water vapor is formed by the upper portion of each of the respective copper tubes. According to another embodiment, the evaporation surface comprises a substantially planar metal sheet. In either embodiment, the heating apparatus is configured to impart heat to a surface of the evaporation member.

The heating apparatus comprises a first light focusing means such as lenses or prisms for directing light onto a surface of the evaporation member, wherein the sun advantageously functions as a light source. The apparatus may further include a concave mirror configured to impart heat to the evaporation member. Another alternative is to provide a supplemental heating device for directing heat to the evaporation member from an alternative energy source such as natural gas or electric heat.

### BRIEF DESCRIPTION OF THE DRAWINGS

The novel features of this invention will be best understood from the accompanying drawings, taken in conjunction with the accompanying description, in which similar characters refer to similar parts, and in which:

FIG. 1 is an overall schematic diagram of the portable water purifier of the present invention.

FIG. 2 is an enlarged cross-sectional view of the steam drum portion of the purifier of FIG. 1.

FIG. 3 is a plan view of the tube bank, upper header and lower header of the purifier of FIG. 1, with the bottom plate removed for clarity.

FIG. 4 is a top plan view of the magnifying glass array of the purifier of FIG. 1.

FIG. 5 is a side elevational view of the magnifying glass array, upper and lower header and tube bank for the purifier shown in FIG. 1.

FIG. 6 is a front perspective view of a multistage embodiment of the water purifier according to the present invention.

FIG. 7 is a side view of a multi-stage embodiment of the present invention showing a primary heating unit with a reflector and lens arrays.

FIG. 8 is a perspective view of the present invention with the cover removed, revealing the heating/cooling elements and flow channels within the evaporative compartments.

FIG. 9 is a side view of the present invention illustrating the flow of water and water vapor.

FIG. 10 illustrates separated corrugated panels comprising a floor panel and a cover panel.

FIG. 11 shows the cover panel oriented overlying the base panel to create multiple air, vapor and water passageways.

### BRIEF DESCRIPTION OF PREFERRED EMBODIMENTS

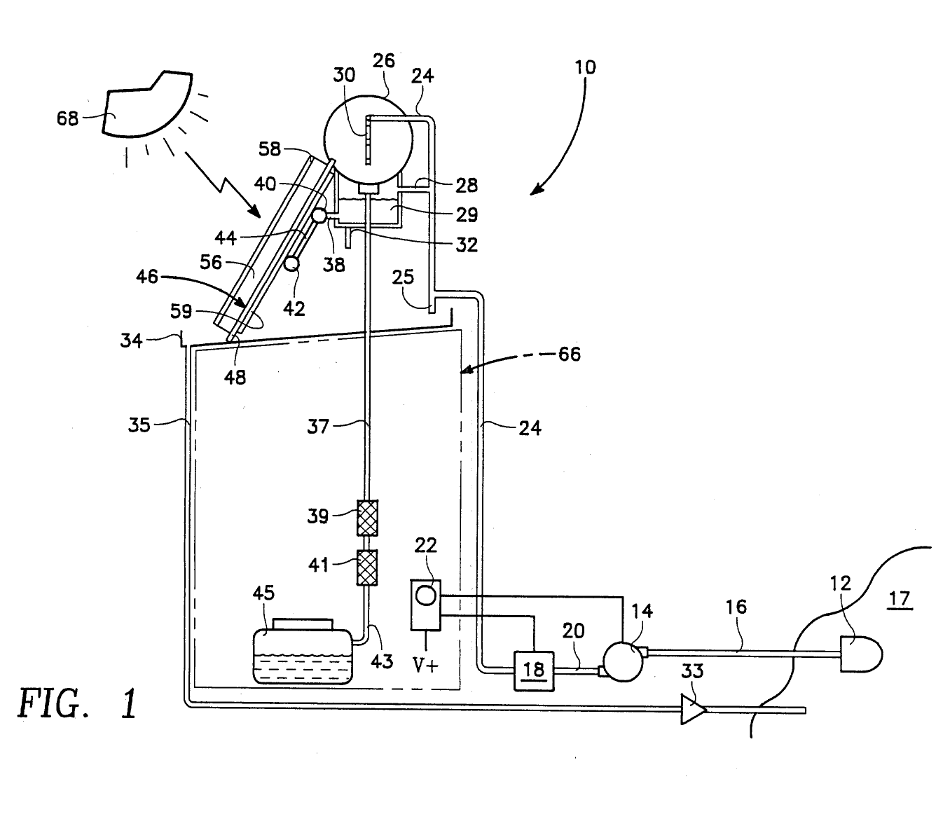

Referring now to the Figures, the overall portable water purifier of the present invention is shown and generally designated by reference numeral 10. With reference to FIG. 1, the purifier includes a strainer 12 which is connected in fluid communication with pump 14 via seawater inlet pipe 16. Strainer 12 is submerged in a seawater reservoir 17 and removes large particulate matter from the seawater as the seawater is transported from reservoir 17 to seawater inlet pipe 16 for subsequent purification by purifier 10.

A solenoid valve 18 is connected in fluid communication with the outlet side of pump 14 via pump outlet pipe 20. As depicted in FIG. 1, the solenoid valve is selectively opened in response to a signal from a timer 22 that is electrically connected to solenoid valve 18. Timer 22 is also electrically connected to the pump for selectively starting and stopping the pump during operation of the purifier.

A solenoid outlet pipe 24 is connected in fluid communication with the outlet of solenoid valve 18. Solenoid outlet pipe 24 bends and then extends vertically upwardly towards steam drum 26. About two thirds of the distance between the solenoid valve and steam drum 26, a pan drain pipe 25 extends downwardly from solenoid pipe 24, as shown in FIG. 1. The pan drain pipe is oriented to allow for a portion of the seawater to be diverted onto drip pan 34 (which is located below the steam drum) when seawater is provided to the purifier 10. As explained in greater detail in the specification herein and in the accompanying drawings, the steam drum functions to condense the steam produced in the evaporation process, forming a liquid condensate of fresh water. As used herein, the terms “steam” and “water vapor” are used interchangeably, referring generally to any form of water in a substantially gas-like state. Also, the terms “raw water” or “seawater” refer to untreated or unpurified water or water that is being drained from the system.

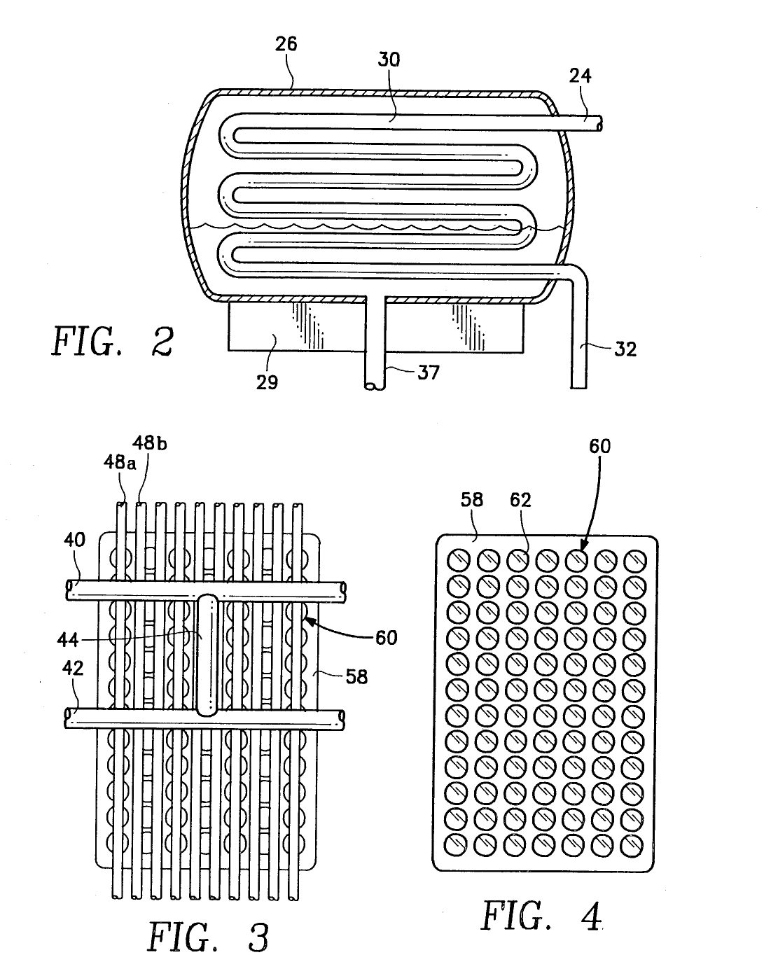

Before the solenoid outlet piping reaches steam drum 26, a recipient inlet pipe 28 branches off from solenoid outlet pipe 24 and extends into water recipient 29, as shown in FIG. 1. Downstream of recipient inlet pipe 28, solenoid outlet pipe 24 passes through the steam drum and merges into cool pipe 30, as best seen in FIG. 2.

Referring primarily now to FIG. 2, the manner in which cool pipe 30 is arranged within the steam drum is more clearly defined. As shown, cool pipe 30 makes a series of turns back and forth within the steam drum to provide an increased surface area for the cool pipe with the steam drum. This allows for increased heat transfer to thereby cool/condense steam within the steam drum during operation of the purifier. The cool pipe passes through the steam drum and terminates at downwardly extending endpipe 32. The cool pipe is in fluid isolation from the interior of the steam drum, so any steam which is condensed within the steam drum is not contaminated by seawater passing through the cool pipe.

As shown in FIG. 1, endpipe 32 is oriented to allow drainage of seawater onto a drain water accumulator shown as drip pan 34. This occurs during operation of the purifier, in much the same manner as pan drain pipe 25. As also shown, pan 34 has an angled orientation. This allows seawater from endpipe 32 and drain pipe 25 to gravity flow across pan 34 and into a pan drain pipe 35 that is connected to the lower side of pan 34. With this configuration, any salts, minerals or impurities that may have collected on the pan 34 during operation of purifier 10 are removed, as the seawater/salts/minerals mixture passes through drain pipe 35, through valve 33 and back to seawater reservoir 17.

Referring back to water recipient 29 in FIG. 1, a recipient outlet pipe 38 is connected in fluid communication with water recipient 29 proximate the bottom edge thereof. The recipient outlet piping is further connected in communication with upper manifold 40, and upper manifold 40 is interconnected to lower manifold 42 via a manifold pipe 44 as best seen in FIGS. 1 and 3.

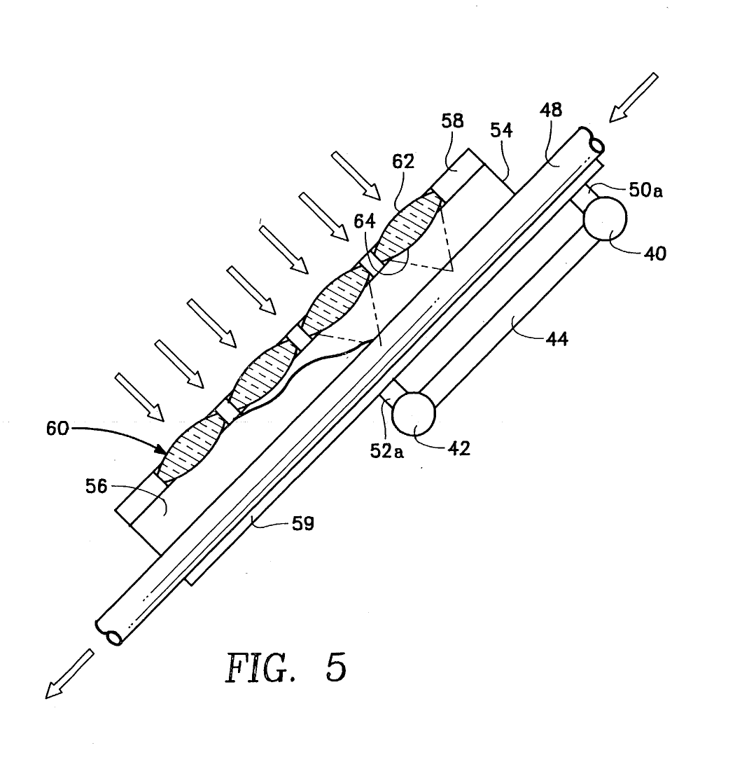

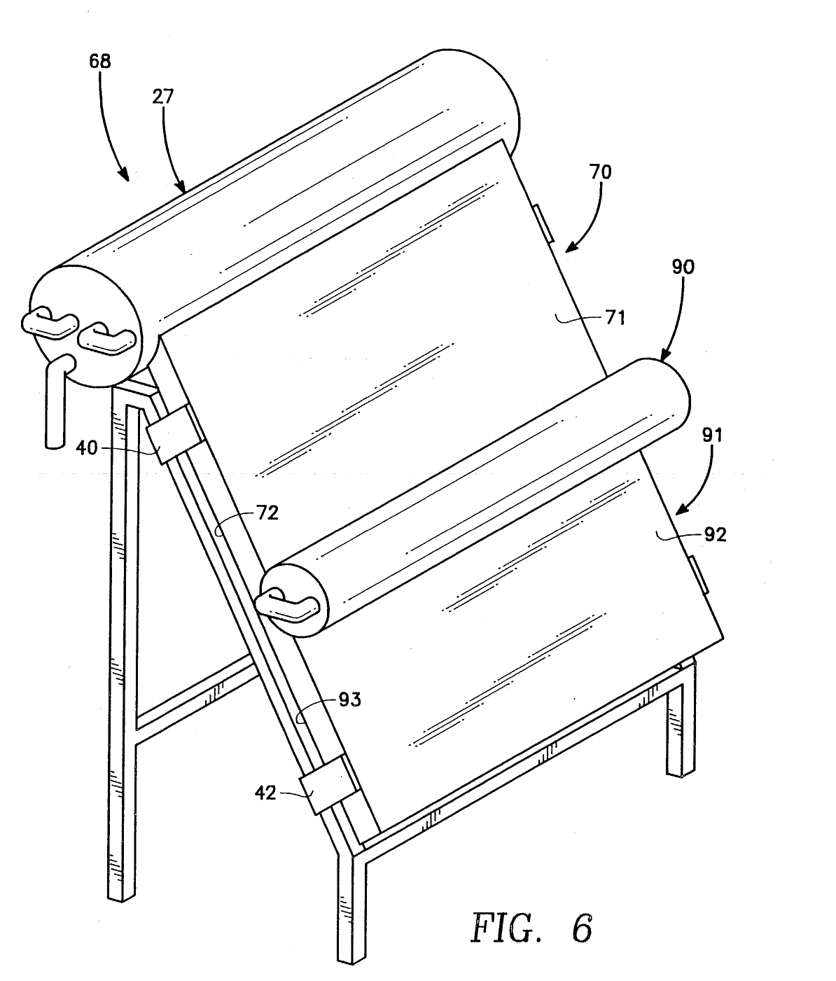

Both the upper manifold and lower manifold are connected to generating tube bank 46. More specifically, generating tube bank 46 comprises a plurality of generating tubes 48, of which tubes 48a and 48b are representative (See FIG. 3), and upper manifold 40 is formed with a series of upper manifold openings (not shown in the Figures). Each upper manifold opening corresponds to a respective generating tube 48 and is connected thereto with an upper tube pipe 50, of which upper tube pipe 50a in FIG. 5 is representative. To do so, tube pipe 50a passes through an plate opening (not shown) in bottom plate 59. In this manner, the other tube pipes 50 each pass through a respective plate opening in bottom plate 59 and interconnect upper manifold 40 with a respective generating tube 48.

In similar fashion, lower manifold 42 is formed with a plurality of lower manifold openings (not shown) and are connected to a respective generating tube with a respective lower tube pipe 52. Each lower tube pipe 52 extends from lower manifold 42 through a respective bottom opening (not shown) in bottom plate 59 and then into a respective generating tube 48. Lower tube pipe 52a in FIG. 5 is representative in this regard.

With the above configuration, a path of fluid flow can be established from the water recipient, through recipient outlet pipe 38 into upper manifold 40, through manifold pipe 44 and into lower manifold 42. From the upper and lower manifolds, a path for fluid flow is simultaneously established from the upper manifold 40 through upper tube pipes 50a and into the upper portions of the generating tubes 48, and from lower manifolds 42 through the lower tube pipe and into the lower portions of the generating tubes 48.

For generating tube bank 46, each generating tube 48 is connected to steam drum 26 at the upper ends of the generating tubes. This configuration allows for steam to flow into steam drum 26 during operation of the purifier as described. The lower ends of the generating tubes are positioned over pan 34, to further allow for any seawater which is not converted into steam to empty onto the drip pan for further transport through pan drain pipe 35 and back to seawater reservoir 17.

Within the steam drum, and as shown in FIGS. 1 and 2, a distilled water pipe 37 is connected to the bottom of the steam drum. Distilled water pipe 37 extends through water recipient 29 and is connected to sand filter 39 and carbon filter 41 (shown in FIG. 1), to thereby provide a flow path for condensed water out of the steam drum. Sand filter 39 removes any minute particulate matter which may remain in the condensed water, while carbon filter 41 removes distasteful compounds from the distilled water. A drinking water pipe 43 interconnects the carbon filter with a purified water container 45 to allow for storage of the purified water. Those skilled in the art will recognize that other known filtration and water treatment methods can be employed, including but not limited to diatomaceous earth and activated carbon/charcoal filters, chemical additives, magnetic and/or electrical fields, radiation, de-ionization and laser beam processes.

As shown in FIGS. 1, 4 and 5, left longitudinal bracket 54 and right longitudinal bracket 56 connect copper plate 58 in a parallel, spaced-apart relationship with generating tube bank 46. A plurality of lenses 60 are embedded in an array within copper plate 58, as best seen in FIG. 4. Each lens is formed with a convex outer surface 62 and a convex inner surface 64 to magnify sunlight passing through the lens. The magnifying lenses are positioned to focus the sunlight on generating tube bank 46 according to known optics principles for reasons more fully described below.

For clarity, only one generating tube bank, plate and lens array are shown in FIG. 1. It is to be appreciated, however, that at least two such structures could be positioned in a roof-like arrangement over a building 66 (shown in phantom in FIG. 1) to take maximum advantage of the orientation of sun 68 with respect to the lenses 60. Further, the purifier 10 of the present invention does not necessarily need to be placed over a building 66. The purifier could simply be placed at a remote location on the ground for operation, provided a seawater or other source of unpurified water was nearby for purification.

In the preferred embodiment, the generating tubes and piping of the present invention are made of a copper or copper alloy. It is to be appreciated, however, that any material having high thermal conductivity properties is suitable for use. The lenses are preferably made of a glass material. However, any material with transparency properties that allows for the lens to focus solar radiation in a manner similar to a magnifying glass, could also be used with the purifier of the present invention. Examples of lens materials are clear polycarbonate plastics, crystalline elements and minerals and resin compounds.

### Operation

During the operation of the present invention, pump 14 transports water from seawater reservoir 17 through strainer 12 and pump 14 to solenoid valve 18. In response to a signal from timer 22 (or a thermostat which can be connected to generating tube bank 46), solenoid valve 18 opens to allow seawater therethrough.

From solenoid valve 18, the seawater travels through solenoid outlet piping 24. A portion of the seawater is transported into water recipient 29 via recipient inlet pipe 28, and the remainder enters the steam drum via cool pipe 30.

After a seawater reservoir is established in the water recipient 29, the inlet seawater is transported from the recipient to upper manifold 40 via recipient outlet pipe 38. Seawater is then moved from upper manifold 40 through manifold pipe 44 and into lower manifold 42. From the upper and lower manifolds, the seawater is transported into the generating tube bank 46 via upper tube pipes 50 and lower tube pipes 52.

Simultaneously with the above events, the sun radiates on the heat conductive plate 59 as indicated by arrows 70 in FIG. 5. When this occurs, the lenses 60 function like an array of magnifying glasses and focus the sun's radiant energy onto the generating tube bank 46. This causes the radiant energy of the sun to be converted into thermal energy to thereby heat the generating tube bank. Because the generating tubes are constructed of thermally conductive materials, such as copper, the generating tube bank retains the thermal energy and becomes hot.

To improve the utilization of sunlight falling within the geometric area of the generating tube bank 46, the tubes 48 can be mounted in close contact with heat conductive plate 59 which may also be constructed of a thermally efficient conductive material, such as copper or copper alloy. In this way, any light falling between two generating tubes 48 will heat the conductive plate and thereby increase the area being heated. This action will enhance the amount of thermal energy imparted to the tubes and render the overall process more efficient.

Within each generating tube 46, once the seawater comes into contact with the inside surface of the generating tube 48 (which is hot because of the retained thermal energy), a portion of the seawater will vaporize into steam. Once this occurs, the steam will rise and pass through the upper portion of each respective generating tube into the steam drum. The brine (the seawater that did not vaporize), drains out of the bottom of the generating tubes 48 and onto pan 34.

As the steam flows into the steam drum, it is cooled by the seawater running through the cool pipe 30. When this occurs, the steam condenses into a liquid and drops by gravity into a water reservoir at the bottom of the drum. From the reservoir, the water is transported through distilled water pipe 37, through the sand filter 39 and carbon filters into purified water container 45.

Meanwhile, the brine that drains from the generating tubes is collected in pan 34. Seawater from cool pipe 30 also drains into pan 34 via endpipe 32. Similarly, inlet seawater from pan drain pipe 25 flows into pan 34. The accumulated brine and seawater flows out of pan 34 through pan drain pipe 35 and back to seawater reservoir 17 and/or an alternative waste reservoir.

### Multi-Stage Embodiments

FIGS. 6-9 illustrate alternative embodiments of the present invention, including a multi-stage embodiment, and the substitution of an enclosure in place of the generating tube bank 46. Those skilled in the art will understand that embodiments discussed previously, comprising generating tube banks 46, can be configured in a multi-stage embodiment as shown in FIGS. 6-9.

A basic multi-stage version of the invention is shown generally by reference 68 in FIG. 6. It comprises an upper stage 70 coupled at its upper end to an upper steam drum 27. There is also a lower stage 91 coupled to a lower steam drum 90. An upper manifold 40 provides untreated water to the upper stage 70, and a lower manifold 42 provides untreated water to the lower stage 91.

Each stage may comprise a part of an elongated housing which is separated by a vapor barrier in a manner to be described hereinafter. Or, the stages may comprise enclosed upper and lower housings that are oriented at an acute angle from horizontal, so that entering water will flow downwardly by gravity and generated steam will flow upwardly in a manner to be described. The housings shown have a rectangular shape, but round or other polygonal shapes could be used. Of course, the larger the surface area being exposed to solar radiation and the more thermally conductive the enclosure walls are, the more distilled water capacity the device will have.

The upper stage is comprised of an upper evaporative floor member 72, and an overlying upper cover 71. The floor member and cover includes interconnected walls that define a hollow interior water heating chamber. Similarly, the lower stage comprises an evaporative lower floor member 93 and a lower cover 92.

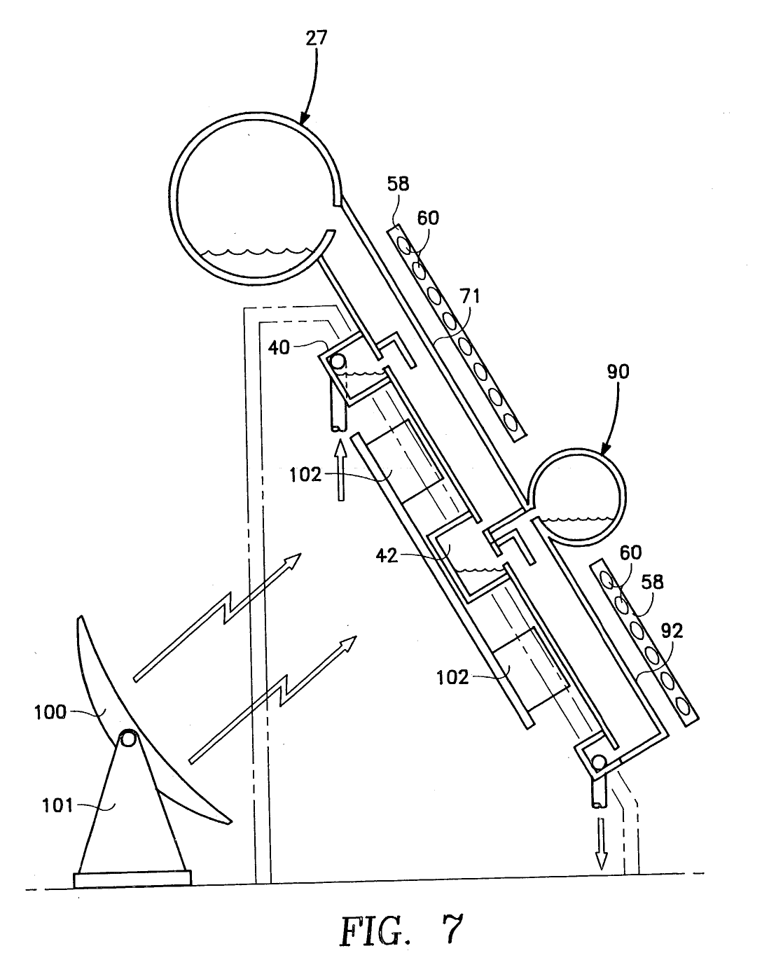

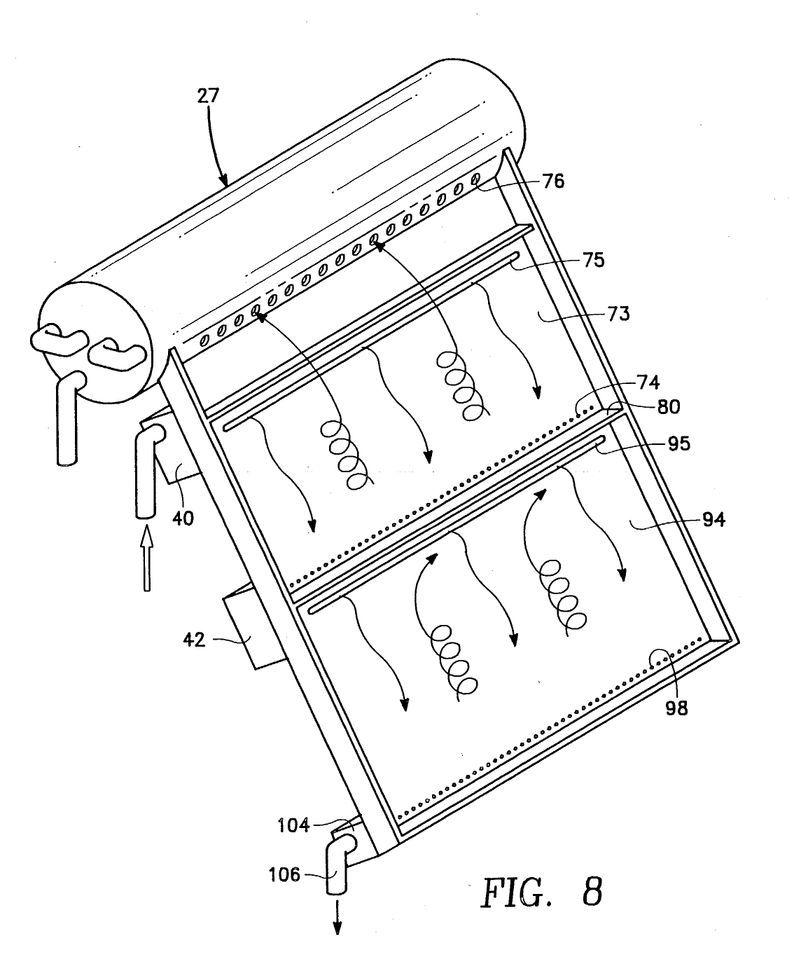

FIG. 7 illustrates a side view of the basic multi-stage embodiment 68 further comprising a concave reflective mirror 100 directing solar radiation toward the outer surfaces of the upper and lower evaporative floor members 72, 93. Optionally, mirror 100 may be mounted on a pivoting mount 101, thereby allowing the mirror to rotate in accordance with the sun's position over the course of a day, and throughout the year. An automatic tracking device (not shown) may also be used to track the sun's position, and direct maximum light upon the outer surfaces of the evaporation floor members 72, 93. The array of lens 60 shown in FIGS. 4 and 5 could also be positioned above the upper and lower covers 71, 92 to further concentrate solar radiation upon the stage housings without heating the steam drums, where a cool environment is desired for condensing the water vapor.

FIG. 7 also illustrates the use of supplemental heaters 102 to increase the production of steam and/or to continue operation of the device on cloudy days. As shown, the heaters are positioned directly adjacent the underside of upper and lower floor members 72, 93.

The supplemental heaters 102 may be connected to a swivel mount so that they may be rotated away from beneath the floor members when sunlight is available for heating. Alternatively, the heaters 102 can be mounted on a detachable mechanism so that the heaters can be removed entirely when sunlight is available. The heaters may be powered by a combustible energy source, such as natural gas, but can also utilize electricity. The thermal output of each heater is preferably controllable in a manner known in the art.

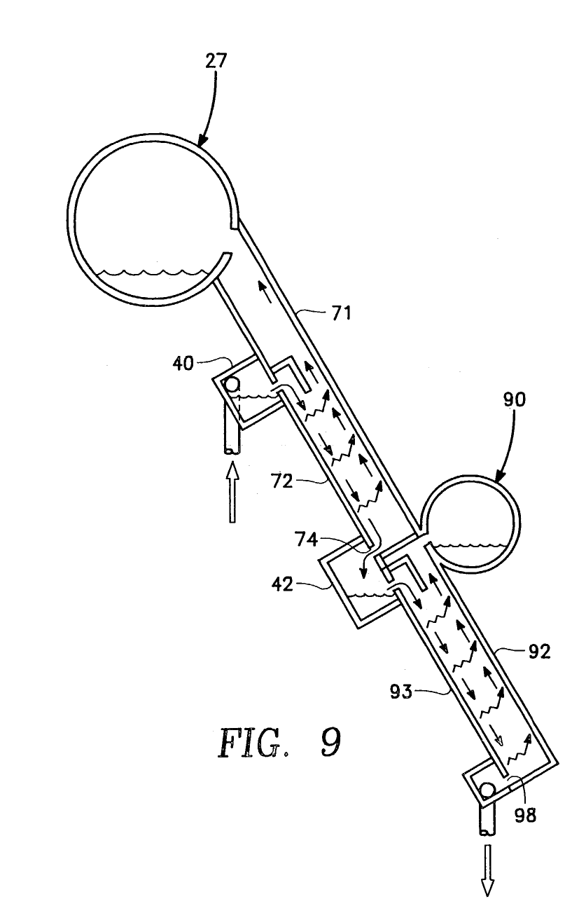

Operation of the multi-stage version of the device can best be understood by reference to FIGS. 8 and 9. FIG. 8 depicts the basic two stage embodiment 68 of FIG. 6 wherein the lower steam drum 90 and the covers 71, 92 have been removed for illustrative purposes. Raw water from a selected source is pumped to the upper manifold 40 in manner described in relation to FIG. 1. From the manifold, the raw water flows through a water distribution means for evenly distributing water over the floor members. As shown, the distribution means is an elongated inlet slot 75. However, separate orifices, flow lines, baffles or floor member grooves could be used. From inlet slot 75, water cascades by gravity down the inner surface 73 of evaporative floor member 72. At this point, it is expected that the floor members and covers will have been exposed to sufficient heat energy to attain a temperature that is effective for converting at least a portion of the incoming raw water to steam. To enhance efficiency, a vapor barrier 80 may be used to delineate between the upper and lower stages. In this way, steam produced in one stage will not pass into a second stage in route to a steam drum.

Steam produced in the upper stage 70 is guided by the upper cover 71 to multiple vapor ports 76 that extend through the wall of upper steam drum 27. As the steam passes through the vapor ports, it is condensed by interior cooling pipes 30, as previously described. Water in the first stage 70 not converted to steam, flows entirely down the evaporative surface 73 and drains out multiple drain holes 74 at the bottom of the upper stage, from where it is collected into the lower manifold 42. The collected water, which is now in a heated state, then passes through hot water inlet opening 95, and flows down the inner surface 94 of the lower floor member 93. Steam produced in the lower stage 91 travels upward along the lower cover 92 until it passes through vapor ports (not shown) that extend through the walls of lower steam drum 90 in a manner similar to the row of ports in upper steam drum 27. The remaining water passes through multiple drain holes 98 extending through the bottom end of lower floor member 93. From the drain holes 98, the undistilled water moves into drain manifold 104 where it may be returned to the raw water source by return line 106.

An advantage of re-using outlet water from the first stage 70 for the second stage 91 is that water has already undergone heating during its descent in the first stage and is, therefore, nearer to evaporation when used in the second stage. This arrangement results in more vapor and more fresh water production.

To introduce water in the lower stage at the highest possible temperature, it is desired that the amount of un-heated water entering the lower manifold be controlled and minimized. However, to avoid building up salt or scale on the evaporative surface, there should be sufficient water in the lower manifold to maintain a flow of water all the way down the lower stage. Because of this, a controllable supply of external water (e.g., sea water) to the lower stage is desired. The amount of water should be the minimum amount necessary to maintain a flow of water down the surface, thereby maximizing the temperature of the water flowing through the stage, and the production of water vapor within the stage. Although only two stages are illustrated in FIGS. 6-9, those skilled in the art will recognize that there is no limit to the number of stages that can be implemented.

An advantage of the planar surface design of FIGS. 6 and 7, is that the entire planar evaporation surface 73, 94, and not simply the surfaces of a generating tube 48, has direct contact with water. This maximizes both the surface area of water for evaporation, and also maximizes the surface area of the heated evaporative surfaces 73, 94 in contact with the water.

Advantages of the above multi-stage embodiments, and the dual heating of the front and back surfaces shown in FIGS. 6-9, can be understood in light of the thermodynamic and heat transfer characteristics of the present invention. Water flowing down a planar surface (or a tube according to the previous embodiments discussed herein) is coolest when it begins its descent. That is, it has been exposed to no solar heating at the beginning of the process. As the water flows down the planar evaporation surface 73, 94 or down a generating tube 48, the water is progressively heated through contact with the hot evaporation surfaces. Simultaneously, water vapor is simultaneously flowing up the same space, and is in constant contact with the counter flowing water.

Because the water at the top of a tube 48 or planar surface 73, 94 is cooler than water at the bottom, as the water vapor ascends to the steam drum, the ascending vapor is exposed to progressively cooler and cooler water. As such, some of the water vapor condenses back into a liquid before entering the steam drum. This process is counter productive to the goal of channeling a maximum amount of water vapor into a steam drum for condensation into recoverable fresh water. However, the multi-stage embodiments of the present invention reduce the distance that water vapor must travel before being collected in a steam drum, thereby minimizing the loss of fresh water through pre-mature condensation. Use of vapor barrier 80 also helps to prevent steam produced in a lower stage from entering an upper stage and being prematurely condensed.

Although the multi-stage embodiments of FIGS. 6-9 are presented in conjunction with planar evaporation surfaces, those skilled in the art will understand that evaporative structures and surfaces of all types may be used, as well as uneven and textured planar surfaces.

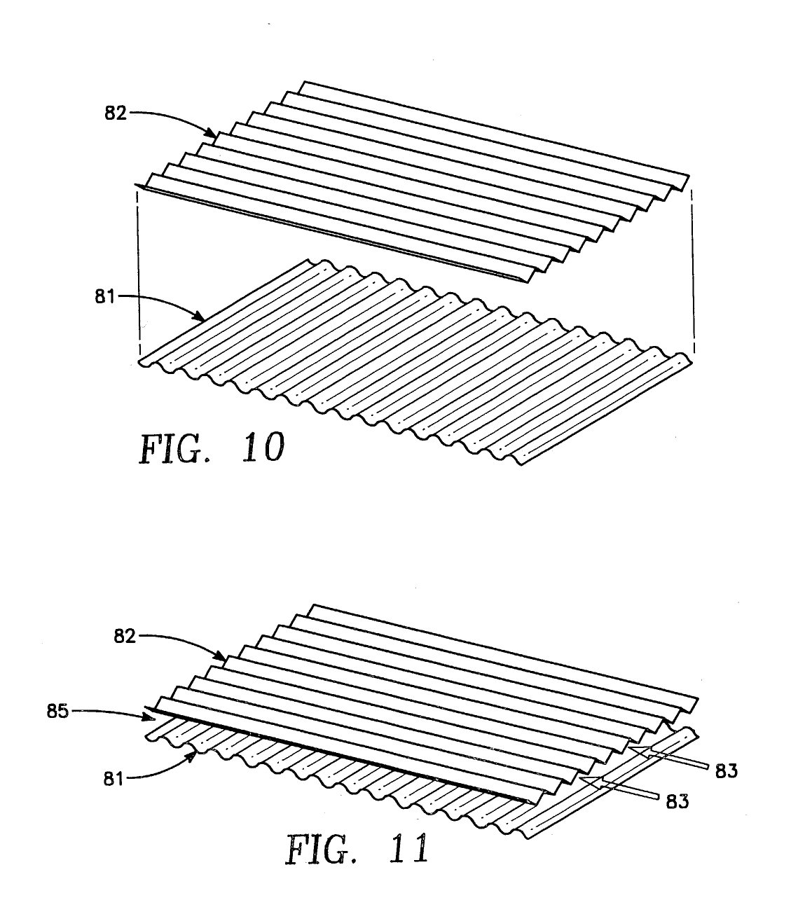

FIGS. 10 and 11 illustrate an alternative evaporation member and cover comprising a corrugated bottom sheet 81, and a corrugated cover sheet 82. The cover is juxtapositioned so that the longitudinal alignment of its grooves and ridges are about 90° from the grooves and ridges of bottom sheet 81. When the cover is placed upon the bottom sheet as shown in FIG. 11, an irregular heating chamber 85 is created in the interstices between the grooves and ridges.

The above configuration enlarges the heating surface area and also urges a splashing of water. This action further enhances the formation of water vapor, especially if the cover 82 is heated.

Although the bottom sheet 81 is depicted as being a corrugated, other shapes or surface textures could be used, such as dimpled sheets, sheets embossed with geometric shapes and sheets with irregular upraised surfaces. Still further, the covers may be removable by fasteners or hinge parts to facilitate cleaning and removal of salt deposits. It is also expected that the corrugations of bottom sheet 81 will be aligned in a direction about perpendicular with the flow of water, thereby creating better contact with the cover. Additionally, the increased surface area of the corrugated cover 82 is particularly advantageous in applications wherein the cover is heated, thereby increasing the surface area from vapor formation. Again, this also reduces the amount of vapor condensing back into water before entering the steam drum.

While the portable water purifier, as herein shown and disclosed in detail, is fully capable of obtaining the objects and providing the advantages above stated, it is to be understood that the above described embodiments are merely illustrative of the invention.

I claim:

1. A water distillation apparatus comprising:
a. a first thermally conductive evaporation member having a first end and a second end, the first end being disposed at a higher altitude than the second end, such that water can gravity flow down said first evaporation member;
b. a first water inlet proximate the first end of said first evaporation member, wherein the first water inlet is configured to receive water from a water source and to provide a flow of water down said first evaporation member;
c. a first heating apparatus configured to impart heat into the water flowing down said first evaporation member, thereby converting at least a portion of said water into water vapor;
d. a first water outlet proximate the second end of the first evaporation member for draining the water from the second end of the first evaporation member; and,
e. a first steam drum in communication with said heating apparatus for condensing said water vapor into fresh water.

2. The water distillation apparatus of claim 1 wherein said first evaporation member comprises a plurality of thermally conductive tubes.

3. The water distillation apparatus of claim 2 wherein said thermally conductive tubes are in thermal communication with a heat conductive plate.

4. The water distillation apparatus of claim 1 wherein said first evaporation member comprises a an enclosed housing that includes a floor member and an overlying cover.

5. The water distillation apparatus of clm 4 wherein said heating apparatus directs heating energy to at least said floor member.

6. The water distillation apparatus of claim 1 wherein the first heating apparatus comprises a light focusing member configured to direct light onto a surface of said first evaporation member.

7. The water distillation apparatus of claim 4 wherein the first heating apparatus further comprises a light focusing member configured to direct light onto said housing.

8. The water distillation apparatus of claim 4 wherein said floor member has a geometric shape that induces splashing of said water against said cover as said water flows across said floor member.

9. The water distillation apparatus of claim 6 further comprising a supplemental heating source located adjacent said first evaporation member.

10. The water distillation apparatus of claim 9 wherein said first heating source comprises a light focusing member that directs light onto a surface of said first evaporation member and said supplemental heating source is movable between a first and second position, wherein said first position is suitable for imparting heat to said first evaporation member, and said second position is configured to minimize interruption of said light directed to said first evaporation member.

11. The water distillation apparatus of claim 10 wherein an amount of heat produced by said supplemental heating source is controllable.

12. The water distillation apparatus of claim 1 further comprising a controller for controlling an amount of said water supplied to the first water inlet.

13. The water distillation apparatus of claim 5 further comprising a second evaporation member coupled to said first evaporation member.

14. The water distillation apparatus of claim 13 wherein said second evaporative member has an inlet and wherein said water from said first water outlet is channeled into said inlet.

15. The water distillation apparatus of claim 14 wherein said first evaporation member and said second evaporation member are oriented on a common geometric plane.

16. The water distillation apparatus of claim 15 further comprising a second steam drum having an upper end, wherein said first steam drum is oriented proximate the first end of said first evaporation member, and said second steam drum is oriented proximate said upper end.

17. The water distillation apparatus of claim 1 further comprising a filtering station coupled to said first steam drum, wherein said water vapor entering said first steam drum is condensed into distilled water and channeled through said filtering station.

18. An assembly for distilling raw water comprising:
a. at least one upwardly inclined steam generating means for converting said raw water to steam, said steam generating means having an upper section, a midsection and a lower section;
b. an upper manifold in communication with said upper section;
c. a lower manifold in communication with said mid-section;
d. a steam drum having a drum interior containing cooling means for condensing said steam to distilled water, said cooling means in communication with said raw water, having a raw water outlet in communication with said upper manifold;
e. a distilled water container in communication with said drum interior;
f. a drain water accumulator in communication with said lower section; and,
g. a solar radiation focusing means for directing solar radiation onto said steam generating means.

19. The assembly of claim 18 wherein said steam generating means comprises elongated tubes constructed of heat conductive material.

20. The assembly of claim 19 wherein said steam-generating means includes a heat conductive plate adjacent said elongated tubes.

21. The assembly of claim 20 wherein said focusing means comprises an array of magnifying lenses positioned adjacent said elongated tubes.

22. The assembly of claim 18, wherein said steam generating means comprises an enclosed housing comprising a floor member and an overlying cover interconnected with side walls.

23. The assembly of claim 22 wherein said mid-section comprises the mid-portion of said housing, including a vapor baffle extending across said mid-portion to divide said housing into an upper heating chamber and a lower heating chamber, said lower heating chamber having an interior vapor space with a lower steam drum adjacent said vapor baffle in communication with said interior vapor space.

24. The assembly of claim 23 wherein said upper manifold and said lower manifold are in fluid communication with each other.

25. The assembly of claim 22 wherein said floor member and said overlying cover are constructed of any one or combination of a member selected from the group consisting of, corrugated sheet material, dimpled sheet material, sheet material embossed with geometric shapes, sheet material having an irregular upraised surfaces.

26. The assembly of claim 18 wherein said steam generating means has an upper side and an underside, said focusing means comprising an adjustable concave mirror for directing solar radiation to said underside, and an array of magnifying lenses for directing solar radiation to said upper side.

27. A method of distilling raw water, the method comprising the steps:
a. flowing said raw water through a first heating chamber;
b. heating the first heating chamber by focusing sunlight on said first heating chamber with a first optical member;
c. vaporizing a portion of said raw water into steam by flowing through said first heating chamber;
d. collecting a portion of said steam within a first steam drum;
e. condensing the water vapor into condensate; and,
f. collecting said steam within a collection chamber.

28. The method according to claim 27 wherein said heating chamber comprises a heat conductive tube.

29. The method according to claim 27 wherein said heating chamber comprises a floor and cover interconnected by side walls.

30. The method according to claim 27 wherein said first optical member comprises a mirror, and wherein the step of directing sunlight on said first heating chamber comprises the step of directing sunlight onto a surface of the floor.

31. The method according to claim 30 further comprising the step of focusing light onto said cover with a second optical member.

32. The method according to claim 30 further comprising the steps:
a. flowing raw water through a second heating chamber comprising a second floor and cover interconnected by side walls;
b. heating said second heating chamber by directing sunlight on said second heating chamber;
c. vaporizing a portion of said raw water flowing through said second heating chamber, thereby forming water vapor;
d. collecting a portion of said water vapor from said second heating chamber within a second steam drum;
e. condensing said water vapor within said second steam drum into condensate; and
f. collecting the condensate from the second steam drum within said collection chamber.

33. The method according to claim 32 wherein said floor of the first heating chamber and said second floor are oriented on a common plane.

34. The method according to claim 33 further comprising the step of directing water from a lower level of said first heating chamber to an upper level of said second heating chamber.

35. The method according to claim 34 further comprising the steps:
a. directing light onto said first heating chamber with a second optical member; and
b. directing light onto a surface of the top of said second heating chamber with a third optical member.

36. The method according to claim 34 wherein said second optical member comprises at least one lens.

37. The method according to claim 33 wherein said floor of the first heating chamber and said second floor comprise a contiguous surface.

38. The method according to claim 33 comprising a vapor barrier between said first heating chamber and said second heating chamber, the method further comprising the steps of:
a. restricting water vapor flow from said second heating chamber to said first heating chamber; and
b. restricting water vapor flow from said first heating chamber to said second heating chamber.

39. The method according to claim 38 wherein said vapor barrier fully separates said first heating chamber and said second heating chamber, the method further comprising the step of restricting a flow of water between said first and second heating chambers.

40. The method according to claim 27 wherein the step of condensing the water vapor into condensate comprises the steps of:
a. flowing raw water through a cooling channel within the steam drum; and
b. flowing said water vapor against said cooling channel.

41. The method according to claim 30 wherein said mirror comprises a curved surface, the method further comprising the step of adjusting an angle of the mirror according to positions of the sun.
